(19) United States
(12) Patent Application Publication
(10) Pub. No.: US 2007/0062931 A1
(43) Pub. Date: Mar. 22, 2007

(54) Quartz heater tube module

(76) Inventor: Cheng Ping Lin, Taipei (TW)

Correspondence Address: LOWE HAUPTMAN BERNER, LLP, 1700 DIAGONAL ROAD, SUITE 300, ALEXANDRIA, VA, 22314, US

(21) Appl. No.: 11/435,137

(22) Filed: May 17, 2006

(30) Foreign Application Priority Data
Sep. 9, 2005 (TW) 094215496

(51) Int. Cl. H05B 3/02

(52) U.S. Cl. 219/481

(57) ABSTRACT

Disclosed is a quartz heater tube module in which the individual quartz heater tube proper has a first and a second coverings covered on the outer surface of the glass tube. The first covering is provided with a first electrode in electrical connection with an electrode of the quartz heater tube proper; and the second covering is provided with a second electrode in electrical connection with the other electrode of the quartz heater tube proper. In this manner, the quartz heater tube proper is securely protected by the aforesaid two coverings from breaking with an external impact. A plurality of tube propers can be connected in series or parallel by adaptive sleeves so as to form an impact resistant quartz heater tube module.

### BACKGROUND OF THE INVENTION

1. Field of the Invention

The present invention relates to a quartz heater tube module. In particular, a plurality of quartz heater tubes combined to form a quartz heater tube module so as to facilitate assembling and testing.

2. Description of the Prior Art

The heating device such as a conventional electric water heater, one or several quartz heater tube is associated with a water supply pipe so as to heat up the water flowing in the water supply pipe thereby the water heated to a required temperature can be obtained.

However, the quartz heater tube is easy to break by impact as it is formed of fragile glass so that it is difficult to pass the test as a qualified safety product. It is difficult to group a plurality of quartz heater tubes to form into a module by reason of its slippery glass surface.

It is what the reason the inventor of the present invention has endeavored for years by continuous research and experimentation attempting to find out the remedy to rectify the inherent short-comings of the conventional quartz heater tubes described above, and at last has succeeded in coming up with the present invention.

### SUMMARY OF THE INVENTION

Accordingly, the main object of the present invention is to provide a quartz heater tube module in which a plurality of quartz heater tubes are combined in a unit with proper means easy for assembly and production test.

To achieve the above object, the individual quartz heater tube proper in the module has a first and a second coverings covered on the outer surface of the glass tube. The first covering is provided with a first electrode in electrical connection with an electrode of the quartz heater tube proper; and the second covering is provided with a second electrode in electrical connection with the other electrode of the quartz heater tube proper. In this manner, the quartz heater tube proper is securely protected by the aforesaid two coverings from breaking caused by an external impact force. Furthermore, a plurality of quartz heater tube propers can be connected in series or parallel by adaptive sleeves bridging across the end terminals of the adjacent tube propers so as to form an impact resistant module qualified for the production test.

### BRIEF DESCRIPTION OF THE DRAWINGS

The above object and other advantages of the present invention will become more apparent by describing in detail the preferred embodiment of the invention with reference to the appended drawings below:

FIG. 1 is a cross sectional view of the present invention.

FIG. 2 is a perspective view of the present invention.

FIG. 3 is an assembly view of the present invention.

FIG. 4 is an exploded illustrative view for an individual quartz heater tube according to the present invention.

### DETAILED DESCRIPTION OF THE PREFERRED EMBODIMENTS

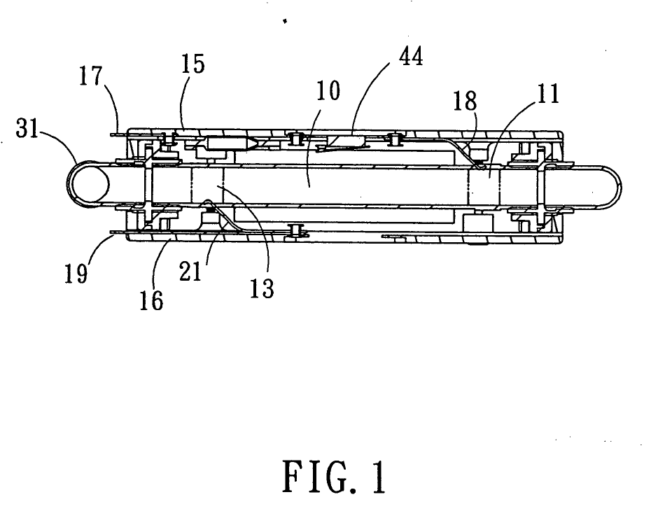

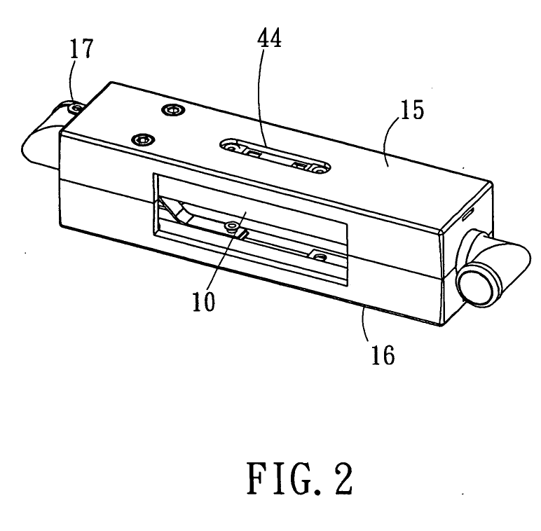

Referring to FIG. 1 through FIG. 4, the quartz heater tube of the present invention comprises a tube proper 10 with an electric heater film coated on its surface, and an electrode 11 (13) is respectively formed on each of the two terminals of the electric heater film such that the tube proper 10 is heated by applying a voltage between the electrodes 11 and 13.

The quartz heater tube proper 10 is covered with a first and a second coverings 15 and 16 on its outer surface. The first covering 15 has a first strip type electrode 17 with one end projected out of the first covering 15; while the other end thereof is provided with a metal spring leaf 18, and the spring leaf 18 is connected to the electrode 11 of the tube proper 10 so that the first strip type electrode 17 is electrically in connection with the electrode 11. Similarly, the second covering 16 has a second strip type electrode 19 with one end projected out of the second covering 16; while the other end thereof is provided with a metal spring leaf 21, and the spring leaf 21 is connected to the electrode 13 of the tube body 10 so that the second strip type electrode 19 is electrically in connection with the electrode 13.

With such a scheme, the quartz heater tube proper 10 is securely protected by the first and second coverings 15, 16 not to be destroyed with an external impact. Besides, a plurality of tube propers 10 can be connected in series or parallel by adaptive sleeves 31 bridged across the terminals of the adjacent tube propers 10 so as to form an impact resistant quartz heater tube module qualified for the production test.

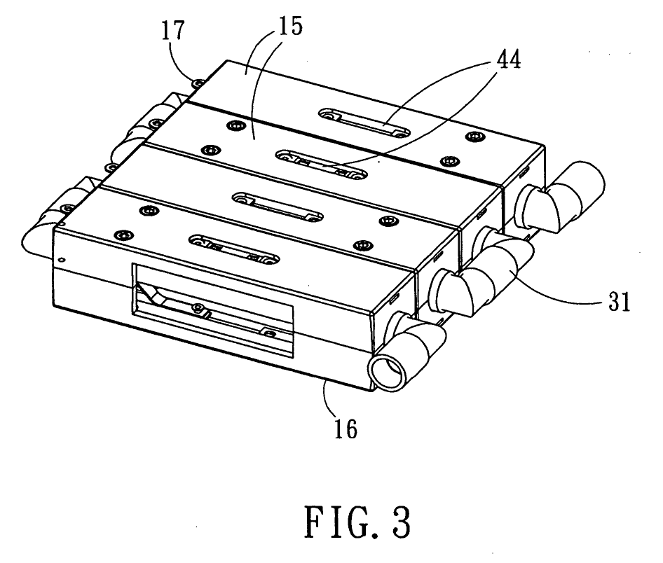

As shown in FIG. 3, the adaptive sleeve may be formed into straight or L shape convenient to connect several tube propers 10 in series or parallel electrically to form a quartz heater tube module.

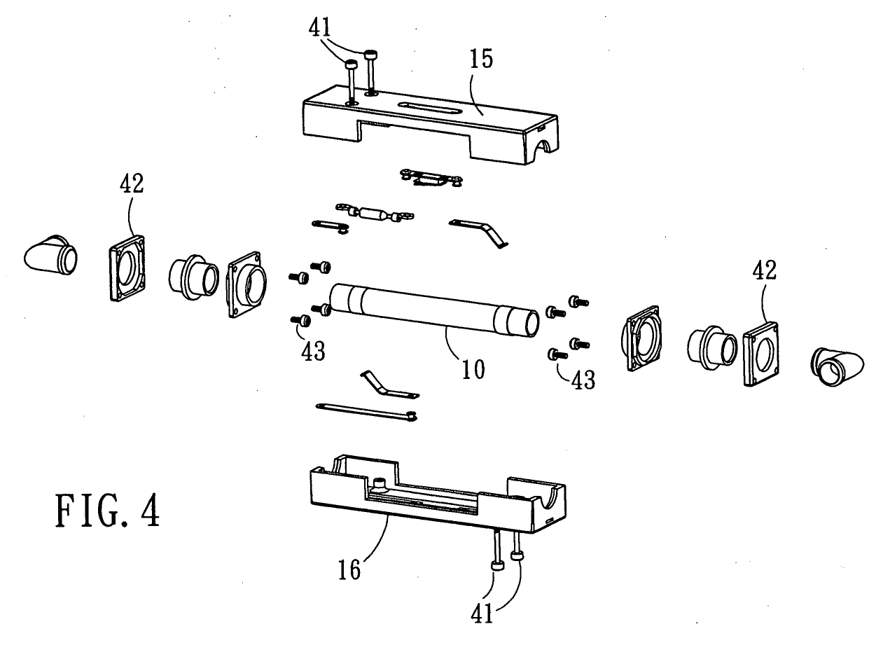

Referring to FIG. 4 again, the first and second coverings 15 and 16 are engaged together by screws 41 to cover on the tube proper 10. A protective cap 42 is engaged to each of the two terminals of the tube body 10 by screws 43.

Referring again to FIG. 1 through FIG. 3, the first strip type electrode 11 is provided with an over temperature protector 44 which is used to interrupt supply current to the tube proper 10 in case it is over heated.

The present invention is a high level technical creation and not simply utilizes conventional technology or knowledge known prior to the application for patent or can easily be made by persons skilled in the arts. Prior to the application for patent, the invention has neither been published or put to public use, nor displayed in an exhibition, therefore the present invention is eligible for applying patent.

Other embodiments of the present invention will become obvious to those skilled in the arts in light of the above disclosure. It is of course also understood that the scope of the present invention is not to be determined by the foregoing description, but only by the following claims.

What is claimed is:

1. A quartz heater tube module formed of:
a plurality of quartz heater tube propers each coated with an electric heater film on its surface, said electric heater film being provided with an electrode on each of the two ends thereof so as to heat up said tube proper by applying a voltage between said two electrodes;
a first and a second coverings covering on the outer surface of said tube proper;
a first strip type electrode formed on said first covering and projecting its one end out of said first covering, while the other end thereof being provided with a metal spring leaf in connection with one of said two electrodes of said tube proper so as to connect said first strip type electrode with said electrode of said tube proper electrically;
a second strip type electrode formed on said second covering and projecting its one end out of said second covering, while the other end thereof being provided with a metal spring leaf in connection with the other electrode of said tube proper so as to connect said second strip type electrode with the other electrode of said tube proper electrically; and
an adaptive sleeve provided to each of the two terminals of said tube proper;
With this structure, said quartz heater tube proper is protected from breaking caused by an external impact force by means of said first and second covering, and a plurality of tube propers can be connected in series or parallel to form said quartz heater tube module using said adaptive sleeves to bridge the adjacent tube propers.

2. The quartz heater tube module of claim 1, wherein said adaptive sleeve is formed into straight shape.

3. The quartz heater tube module of claim 1, wherein said adaptive sleeve is formed into L shape.

4. The quartz heater tube module of claim 1, wherein said first and said second coverings are engaged together by screws.

5. The quartz heater tube module of claim 1, wherein said first strip type electrode is provided with an over temperature protector for interruption of the supply current to said tube proper in case of over heating.
